(19) United States
(12) Patent Application Publication
(10) Pub. No.: US 2025/0389883 A1
(43) Pub. Date: Dec. 25, 2025

(54) Piece of Glass and Rotational Motor to Provide Variable Polarization

(71) Applicant: KLA Corporation, Milpitas, CA (US)

(72) Inventors: Rajeev Patil, Fremont, CA (US); Hong Jiang, Singapore (SG); Christopher Loos, Fremont, CA (US); Tianxiang Zhang, Singapore (SG)

(21) Appl. No.: 18/752,201

(22) Filed: Jun. 24, 2024

(51) Int. Cl. G02B 5/30; G02B 27/28

(52) U.S. Cl. CPC G02B 5/3058; G02B 27/281

(57) ABSTRACT

A polarization system includes a single piece of glass and a motor. The piece of glass includes a first region of bare glass to provide null polarization for light incident on the first region, and also includes a second region of wire-grid glass having a grid of metallic wires, to polarize light incident on the second region. The motor is to rotate the piece of glass.

### TECHNICAL FIELD

This disclosure relates to polarizers, and more specifically to polarizers that are configurable to provide variable polarization, including null polarization.

### BACKGROUND

In optical systems it may be desirable to vary the polarization of light, such that light is provided with different polarizations at different times. Such variation may be achieved using multiple optical elements that are switched into and out of the optical path of the light. This approach takes up a significant amount of space (e.g., in the plane normal to the optic axis), however, and involves switching mechanisms for switching between optical elements. This approach also has limited adjustability and complicates setup and alignment of the optical system.

### SUMMARY

According, there is a need for more elegant and easily configurable polarizers that can provide variable polarization.

In some embodiments, a polarizer includes a single piece of glass. The piece of glass includes a first region of bare glass to provide null polarization for light incident on the first region, and also includes a second region of wire-grid glass having a grid of metallic wires, to polarize light incident on the second region.

In some embodiments, a polarization system includes a single piece of glass and a motor. The piece of glass includes a first region of bare glass to provide null polarization for light incident on the first region, and also includes a second region of wire-grid glass having a grid of metallic wires, to polarize light incident on the second region. The motor is to rotate the piece of glass.

In some embodiments, a method includes providing a single piece of glass. The piece of glass includes a first region of bare glass to provide null polarization for light incident on the first region, and also includes a second region of wire-grid glass having a grid of metallic wires, to polarize light incident on the second region. The method further includes rotating the piece of glass to a first orientation and, with the piece of glass at the first orientation, illuminating a target with light that either passes only through the first region or only through the second region.

### BRIEF DESCRIPTION OF THE DRAWINGS

For a better understanding of the various described implementations, reference should be made to the Detailed Description below, in conjunction with the following drawings.

FIG. 1 is a plan view of a polarizer with a single piece of glass that includes a first region of bare glass and a second region of wire-grid glass, in accordance with some embodiments.

FIG. 2 shows various orientations for the polarizer of FIG. 1 in accordance with some embodiments.

FIG. 3A is a perspective view of a polarization system with the polarizer of FIG. 1 in accordance with some embodiments.

FIG. 3B is a plan view of the polarization system of FIG. 3A in accordance with some embodiments.

FIG. 3C is an exploded view of the polarization system of FIGS. 3A and 3B in accordance with some embodiments.

FIG. 4 is a flowchart illustrating an illumination method in accordance with some embodiments.

FIG. 5 is a block diagram of an optical system in accordance with some embodiments.

FIG. 6 is a plan view of a polarizer with a single piece of glass that includes a first region of bare glass along with second and third regions of wire-grid glass, in accordance with some embodiments.

Like reference numerals refer to corresponding parts throughout the drawings and specification.

### DETAILED DESCRIPTION

Reference will now be made in detail to various embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

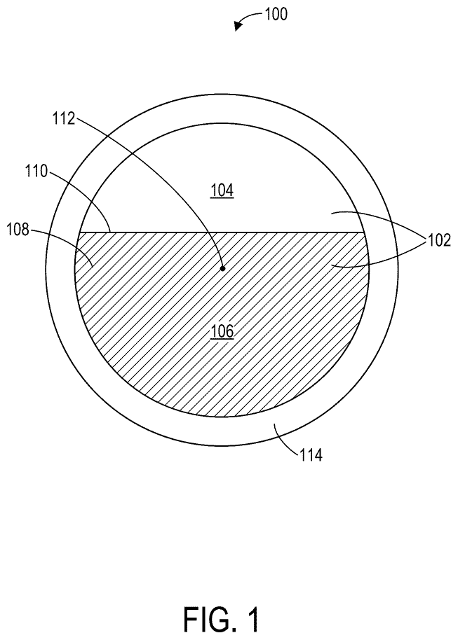

FIG. 1 is a plan view of a polarizer 100 in accordance with some embodiments. The polarizer 100 includes a single piece of glass 102 that has a first region 104 and a second region 106. The first region 104 is bare glass. The second region 106 is wire-grid glass: a grid of metallic wires 108 extends through the second region 106. The metallic wires 108 are parallel to each other. In some embodiments, the grid of metallic wires 108 is contained in a coating applied to the second region 106. The second region 106 may be a majority of the piece of glass 102.

As bare glass, the first region 104 provides null polarization: it does not polarize light that is incident on the first region 104. The grid of metallic wires 108 causes the second region 106 to polarize light that is incident on the second region 106. Light with electric-field vectors parallel to the metallic wires 108 is reflected from the second region 106, while light with electric-field vectors perpendicular to the metallic wires 108 is transmitted through the second region 106.

In some embodiments, the first region 104 and the second region 106 are contiguous. For example, the first region 104 and the second region 106 are separated by a straight line 110, which may be referred to as a parting line. The piece of glass 102 may be circular, as shown in FIG. 1, and the straight line 110 may be a chord of the circle. In some embodiments, the metallic wires 108 are situated at an acute angle with respect to the straight line 110, such that metallic wires 108 are not perpendicular to the straight line 110 but instead terminate on the straight line 110 at the acute angle. For example, the metallic wires 108 may be situated at a 45-degree angle with respect to the straight line 110.

Alternatively, the first region 104 and the second region 106 are not contiguous, or are contiguous but are separated by a parting line that is not straight. Instead of being circular, the piece of glass 102 may have a different shape (e.g., may be a polygon), which may have some degree of rotational symmetry or may be non-symmetric.

The polarizer 100 also includes a frame 114 that surrounds the piece of glass 102. In some embodiments, the frame 114 is metal (e.g., aluminum). The frame 114 may be used to mount the piece of glass 102 in a stage assembly in an optical system.

The piece of glass 102 is rotatable about a point 112 (e.g., a center point) of the piece of glass 102 (i.e., about a rotational axis passing through the point 112 perpendicular to the page of FIG. 1). For example, the piece of glass 102 is circular and the point 112 is the center of the circle. In some embodiments, the point 112 (e.g., the center point) is disposed in the second region 106 (e.g., with the second region 106 being a majority of the piece of glass 102). The point 112 is offset from the optic axis (i.e., from a point at which the optic axis intersects the piece of glass 102). The optic axis is the axis along which light propagates through an optical system that includes the polarizer 100. The optic axis is thus offset from (e.g., and parallel to) the rotational axis for the piece of glass 102.

The offset between the optic axis and the point 112 allows the piece of glass 102 to be rotated so that light propagating along the optic axis is incident either on the first region 104 or on the second region 106. Furthermore, the piece of glass 102 may be rotated to vary the location within the second region 106 on which the light is incident and thereby to vary the orientation of the metallic wires 108 in the grid of metallic wires 108. Varying the orientation of the metallic wires 108 varies the polarization provided by the second region 106. For example, the second region 106, and thus the piece of glass 102, may serve as either a P polarizer or an S polarizer, depending on its orientation. The piece of glass 102 may be rotated to a first orientation at which it acts as a P polarizer, and may be rotated to a second orientation at which it acts as an S polarizer. P polarization refers to light for which the electric-field vector is aligned with the plane of incidence, with the light being a transverse-magnetic wave. S polarization refers to light for which the electric field vector is perpendicular to the plane of incidence, with the light being a transverse electric wave.

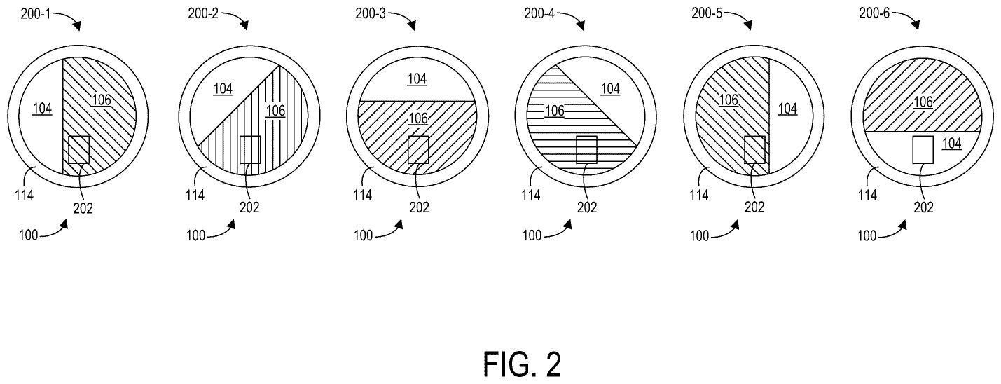

FIG. 2 shows various orientations 200-1 through 200-6 for the polarizer 100 in accordance with some embodiments. The orientations 200-1 through 200-6 are shown with respect to a target 202 that is to be illuminated by light passing through the polarizer 100. Examples of the target 202 include, without limitation, a semiconductor wafer or a reticle (i.e., photomask). In each of the orientations 200-1 through 200-6, the optic axis is incident on the target 202.

In the orientations 200-1 through 200-5, light for the target 202 is to pass only through the second region 106 and not through the first region 104, as shown by the target 202 being stacked with (e.g., above or below) parts of the second region 106. This light may be light that will illuminate the target 202 or light that has illuminated the target 202 and that is collected from the illuminated target 202. Accordingly, the polarizer 100 may be disposed in the illumination path or the collection path of an optical system. While the light for the target 202 is to pass only through the second region 106 for each of the orientations 200-1 through 200-5, the orientation of the metallic wires 108 in the grid of metallic wires 108 differs for different orientations 200-1 through 200-4. By varying the orientation of the metallic wires 108, the polarization provided by the second region 106 is changed. Furthermore, comparison of the orientation 200-1 to the orientation 200-5 shows that the polarizer 100 (and accordingly, the piece of glass 102) is rotatable through 180 degrees with the piece of glass 102 being oriented such that the light for the target 202 is to pass only through the second region 106 and not through the first region 104. The orientation of the metallic wires 108 is the same for the orientations 200-1 and 200-5. The polarizer 100 thus provides full-angle (i.e., 0-180 degree) polarization.

In the orientation 200-6, light for the target 202 is to pass only through the first region 104 and not through the second region 106, as shown by the target 202 being stacked with (e.g., above or below) the first region 104. This light may be light that will illuminate the target 202 or light that has illuminated the target 202 and that is collected from the illuminated target 202. The orientation 200-6 provides null polarization.

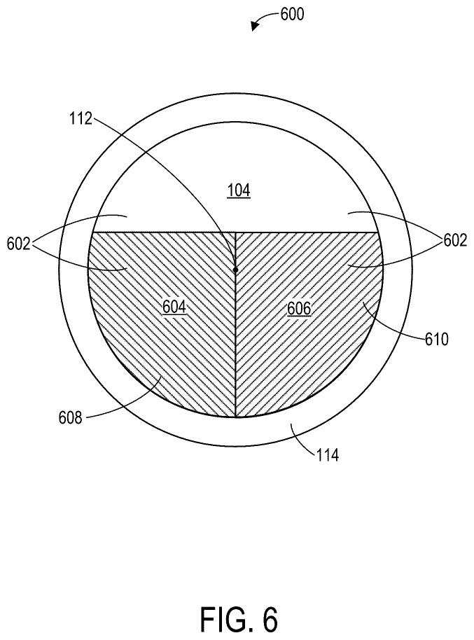

FIG. 6 is a plan view of a polarizer 600 that is an alternative to the polarizer 100 in accordance with some embodiments. The polarizer 600 includes a single piece of glass 602 that has a first region 104, a second region 604, and a third region 606. The first region 104 is bare glass. The second region 604 and the third region 606 are distinct regions of wire-grid glass. A grid of metallic wires 608 extends through the second region 604, while a grid of metallic wires 610 extends through the third region 606. The grid of metallic wires 608 is distinct from the grid of metallic wires 610. In some embodiments, the grid of metallic wires 608 and the grid of metallic wires 610 are contained in respective coatings applied to the second region 604 and the third region 606.

The grid of metallic wires 608 has a different orientation than the grid of metallic wires 610: the metallic wires 608 are parallel to each other, and the metallic wires 610 are parallel to each other, but the metallic wires 608 are not parallel to the metallic wires 610. Instead, there is an offset angle between the metallic wires 608 and the metallic wires 610. The orientations differ such that the direction of the grid of metallic wires 608 when the second region 604 is positioned to have light incident on it is different from the direction of the grid of metallic wires 610 when the third region 606 is positioned to have the light incident on it. For example, the grid of metallic wires 608 may be oriented to provide S polarization when the light is incident on the second region 604 and the grid of metallic wires 610 may be oriented to provide P polarization when light is incident on the third region 606 (or vice-versa). The amount of rotation of the polarizer 600 and piece of glass 602 to switch between P and S polarization is a function of the offset angle between the metallic wires 608 and the metallic wires 610.

The polarizer 600 also includes a frame 114 that surrounds the piece of glass 602. The piece of glass 602, like the piece of glass 102, is rotatable about a point 112 (e.g., a center point) of the piece of glass (i.e., about a rotational axis passing through the point 112 perpendicular to the page of FIG. 6). The point 112 is offset from the optic axis (i.e., from a point at which the optic axis intersects the piece of glass 602), such that the optic axis is offset from (e.g., and parallel to) the rotational axis for the piece of glass 602. The piece of glass 602 may be shaped the same as the piece of glass 102, with the polarizer 600 having the same shape as the polarizer 100.

In some embodiments, the first region 104, second region 604, and/or third region 606 are contiguous. For example, the first region 104 and second region 604 are separated by a first line, which may be straight or curved, and the second region 604 and third region 606 are separated by a second line, which may be straight or curved. Alternatively, the first region 104, second region 604, and/or third region 606 are not contiguous. The first region 104, second region 604, and/or third region 606 may be sized differently than shown in FIG. 6. For example, the second region 604 and third region 606 may be sized smaller than shown in FIG. 6, such that switching between P, S, and null polarization is performed with less than 90 degrees of total rotation of the polarizer 600 and piece of glass 602.

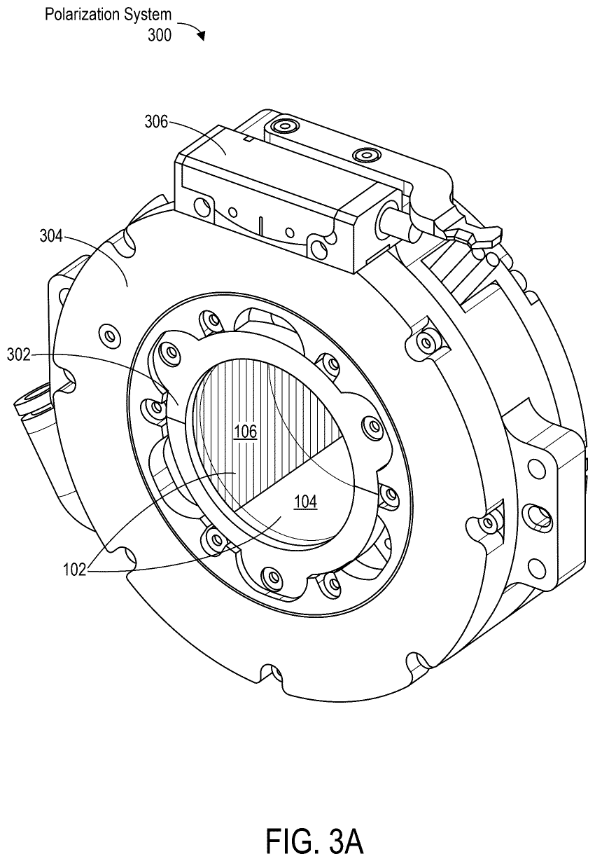

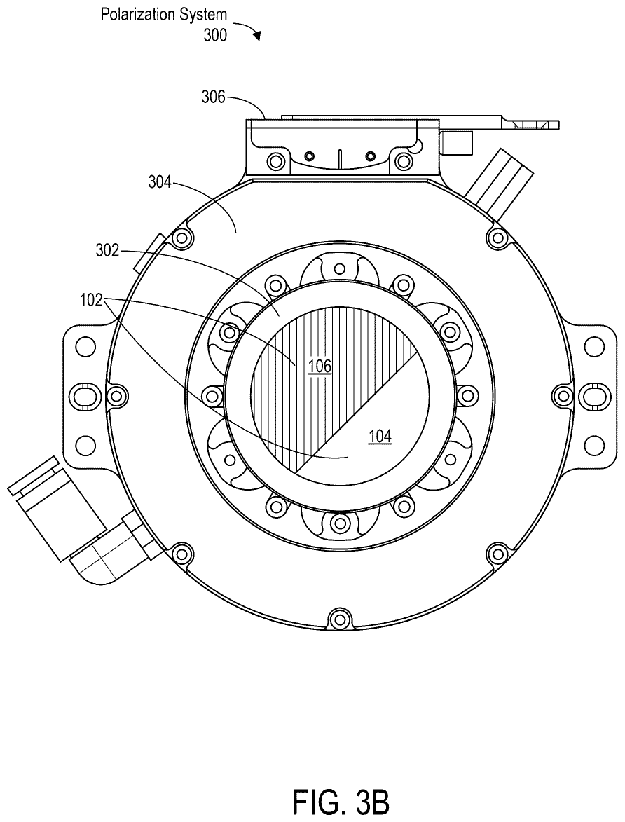

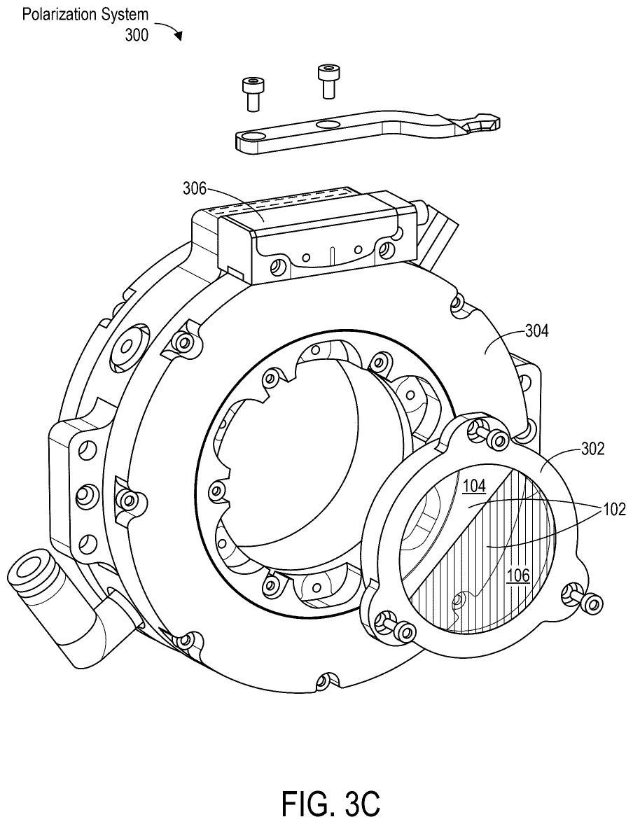

FIGS. 3A-3C are respective views of a polarization system 300 in accordance with some embodiments. FIG. 3A is a perspective view of the polarization system 300. FIG. 3B is a plan view of the polarization system 300. FIG. 3C is an exploded view of the polarization system 300.

The polarization system 300 includes the polarizer 100 (FIGS. 1-2), which includes the piece of glass 102 surrounded by a frame 302. Alternatively, the polarizer 100 may be replaced with the polarizer 600 (FIG. 6). The piece of glass 102 includes the first region 104 and the second region 106 (FIGS. 1-2) (or alternatively, the first region 104, second region 604, and third region 606, FIG. 6). The frame 302 is an example of the frame 114 (FIGS. 1-2, 6). The frame 302 is connected to (e.g., screwed into) a stage assembly 304. The piece of glass 102 is thereby mounted in the stage assembly 304, with the frame 302 mechanically coupling the piece of glass 102 with the stage assembly 304. The stage assembly 304 holds the piece of glass 102 in the optical path of a beam of light in an optical system, with the optic axis of the beam of light passing through the piece of glass 102.

The polarization system 300 also includes a motor 306 that rotates the stage assembly 304, thereby rotating the piece of glass 102 and the polarizer 100. The motor 306 servers as a rotary actuator for the stage assembly 304, polarizer 100, and piece of glass 102. For example, the motor 306 may rotate the polarizer 100 and piece of glass 102 to any of the orientations 200-1 through 200-6 (FIG. 2), as well as additional orientations, in accordance with some embodiments. The motor 306 may rotate the piece of glass 102 through 180 degrees with the piece of glass 102 remaining oriented such that the light for the target is to pass only through the second region 106 and not through the first region 104, as well as rotating the piece of glass 102 to be oriented such that the light for the target is to pass only through the first region 104 and not through the second region 106

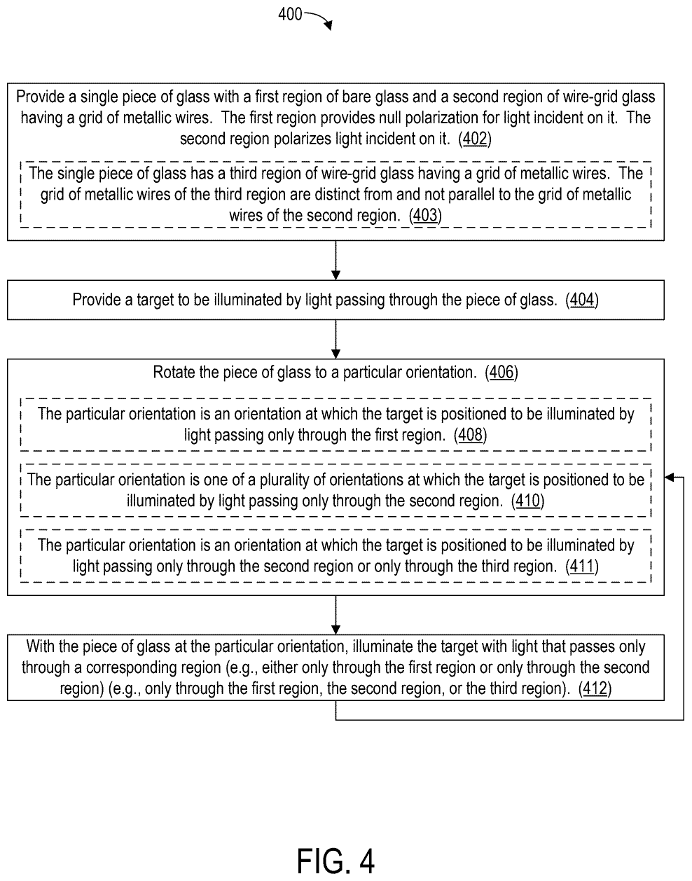

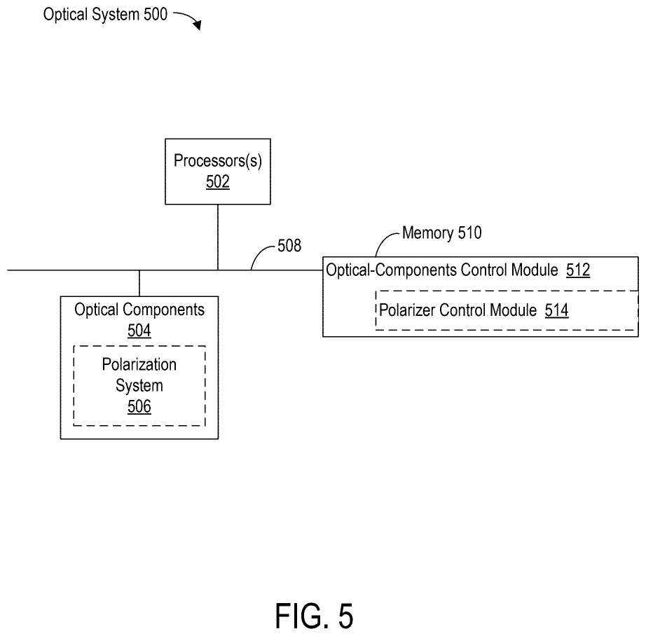

FIG. 4 is a flowchart illustrating an illumination method 400 in accordance with some embodiments. The method 400 may be performed using the polarization system 300 (FIGS. 3A-3C). For example, the method 400 may be performed in the optical system 500 (FIG. 5).

In the method 400, a single piece of glass (e.g., piece of glass 102, FIG. 1; piece of glass 602, FIG. 6) is provided (402) (e.g., is situated in the optical system in which the method 400 is performed). The piece of glass has a first region of bare glass (e.g., first region 104, FIGS. 1-3C and 6) and a second region of wire-grid glass (e.g., second region 106, FIGS. 1-3C; second region 604 or third region 606, FIG. 6) having a grid of metallic wires (e.g., metallic wires 108, FIG. 1; metallic wires 608 or 610, FIG. 6). The first region provides null polarization for light incident on it. The second region polarizes light incident on it. In some embodiments, the single piece of glass also has (403) a third region of wire-grid glass (e.g., third region 606 or second region 604, FIG. 6) having a grid of metallic wires (e.g., metallic wires 610 or 608, FIG. 6). The grid of metallic wires of the third region are distinct from and not parallel to the grid of metallic wires of the second region.

A target (e.g., target 202, FIG. 2) is also provided (404) (e.g., is loaded onto a stage in the optical system in which the method 400 is performed). The target is to be illuminated by light that passes through the piece of glass. The light may be light that will illuminate the target and that passes through the piece of glass on its way to the target. Or the light may be light that has illuminated the target and that is collected from the target, and that passes through the piece of glass after illuminating the target. The piece of glass thus may be disposed in the illumination path or in the collection path of an optical system.

The piece of glass is rotated (406) to a particular orientation. The particular orientation may be (408) an orientation at which the target is positioned to be illuminated by light passing only through the first region (e.g., orientation 200-6, FIG. 2). The particular orientation may alternatively be (410) one of a plurality of orientations at which the target is positioned to be illuminated by light passing only through the second region (e.g., one of the orientations 200-1 through 200-5, FIG. 2). The particular orientation may be (411) an orientation at which the target is positioned to be illuminated by light passing only through the second region or only through the third region.

With the piece of glass at the particular orientation, the target is illuminated (412) with light that passes only through a region corresponding to the particular orientation (e.g., either only through the first region or only through the second region) (e.g., only through the first region, the second region, or the third region).

Repeated iterations of steps 406 and 412 may be performed. For example, in a first iteration, the piece of glass is rotated (406) to a first orientation at which the target is positioned (408) to be illuminated by light passing only through the first region (e.g., orientation 200-6, FIG. 2). With the piece of glass at the first orientation, the target is illuminated (412) with light that passes only through the first region. In a second iteration, the piece of glass is rotated (406) to a second orientation that is one of the plurality of orientations at which the target is positioned (410) to be illuminated by light passing only through the second region (e.g., one of the orientations 200-1 through 200-5, FIG. 2). With the piece of glass at the second orientation, the target is illuminated (412) with light that passes only through the second region. A third iteration may be performed in which the piece of glass is rotated (406) to a third orientation that is another one of the plurality of orientations at which the target is positioned (410) to be illuminated by light passing only through the second region (e.g., another one of the orientations 200-1 through 200-5, FIG. 2). With the piece of glass at the third orientation, the target is illuminated (412) with light that passes only through the second region. The light that passes only through the second region with the piece of glass at the second orientation is provided with a different polarization than the light that passes only through the second region with the piece of glass at the third orientation, because the orientation of the metallic wires in the wire-grid glass at the second orientation is different than at the third orientation. The light that passes only through the first region with the piece of glass at the first orientation is provided with null polarization. The first, second, and third iterations may be performed in any order.

In another example, in a first iteration, the piece of glass is rotated (406) to a first orientation that is one of the plurality of orientations at which the target is positioned (410) to be illuminated by light passing only through the second region (e.g., one of the orientations 200-1 through 200-5, FIG. 2). With the piece of glass at the first orientation, the target is illuminated (412) with light that passes only through the second region. In a second iteration, the piece of glass is rotated (406) to a second orientation that is another one of the plurality of orientations at which the target is positioned (410) to be illuminated by light passing only through the second region (e.g., another one of the orientations 200-1 through 200-5, FIG. 2). With the piece of glass at the second orientation, the target is illuminated (412) with light that passes only through the second region. The light that passes only through the second region with the piece of glass at the first orientation is provided with a different polarization than the light that passes only through the second region with the piece of glass at the second orientation, because the orientation of the metallic wires in the wire-grid glass at the first orientation is different than at the second orientation. A third iteration may be performed in which the piece of glass is rotated (406) to a third orientation at which the target is positioned (408) to be illuminated by light passing only through the first region (e.g., orientation 200-6, FIG. 2). With the piece of glass at the third orientation, the target is illuminated (412) with light that passes only through the first region. The light that passes only through the first region with the piece of glass at the third orientation is provided with null polarization. The first, second, and third iterations may be performed in any order.

In yet another example, in a first iteration, the piece of glass is rotated (406) to a first orientation at which the target is positioned (408) to be illuminated by light passing only through the first region. With the piece of glass at the first orientation, the target is illuminated (412) with light that passes only through the first region. In a second iteration, the piece of glass is rotated (406) to a second orientation at which the target is positioned (411) to be illuminated by light passing only through the second region. With the piece of glass at the second orientation, the target is illuminated (412) with light that passes only through the second region. In a third iteration, the piece of glass is rotated (406) to a third orientation at which the target is positioned (411) to be illuminated by light passing only through the third region. With the piece of glass at the third orientation, the target is illuminated (412) with light that passes only through the third region.

The polarizers 100 (FIGS. 1-2) and 600 (FIG. 6), polarization system 300 (FIGS. 3A-C), and method 400 (FIG. 4) provide variable polarization (e.g., including S, P, and null polarization) as well as easy assembly and alignment with a compact design that saves space and avoids switching mechanisms for switching different components into and out of the optical path.

FIG. 5 is a block diagram of an optical system 500 in accordance with some embodiments. The optical system 500 includes optical components 504, one or more processors 502 (e.g., CPUs), memory 510, and one or more communication buses 508 interconnecting these components. The optical components 504 include a polarization system 506 (e.g., polarization system 300, FIGS. 3A-3C), which includes a polarizer (e.g., polarizer 100, FIGS. 1-2; polarizer 600, FIG. 6) in which a single piece of glass (e.g., piece of glass 102, FIGS. 1 & 3A-3C; piece of glass 602, FIG. 6) has a first region of bare glass (e.g., first region 104, FIGS. 1-3C) and a second region of wire-grid glass (e.g., second region 106, FIGS. 1-3C; second region 604 or third region 606, FIG. 6). In some embodiments, the single piece of glass also has a third region of wire-grid glass (e.g., third region 606 or second region 604, FIG. 6). The one or more communication buses 508 include a communication bus electrically coupling the processor(s) 502 with the polarization system 506. The processor(s) 502 provide commands via this communication bus to the polarization system 506 to rotate the polarizer by specified amounts in order to achieve desired orientations of the polarizer.

Memory 510 includes volatile and/or non-volatile memory. Memory 510 (e.g., the non-volatile memory within memory 510) includes a non-transitory computer-readable storage medium. Memory 510 (e.g., the non-transitory computer-readable storage medium of memory 510) stores an optical-components control module 512, which includes a polarizer control module 514. The optical-components control module 512, including the polarizer control module 514, corresponds to a set of instructions, executable by the processor(s) 502, for controlling operation of the optical components 504 of the optical system 500. For example, the polarizer control module 514 includes instructions for controlling operation of the polarization system 506 (e.g., for performing steps 406-412 of the method 400, FIG. 4). Execution of the instructions of the polarizer control module 514 causes the processor(s) 502 to provide commands to the polarization system 506.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A polarizer, comprising:
a single piece of glass, comprising:
a first region of bare glass to provide null polarization for light incident on the first region; and
a second region of wire-grid glass having a grid of metallic wires, to polarize light incident on the second region.

2. The polarizer of claim 1, wherein the first region and the second region are contiguous.

3. The polarizer of claim 2, wherein the second region composes a majority of the piece of glass.

4. The polarizer of claim 2, wherein:
the first region and the second region are separated by a straight line; and
the metallic wires of the grid are situated at an acute angle with respect to the straight line.

5. The polarizer of claim 4, wherein the acute angle is a 45-degree angle.

6. The polarizer of claim 1, further comprising a frame surrounding the piece of glass.

7. The polarizer of claim 1, wherein:
the piece of glass is rotatable about a center point of the piece of glass; and
the center point is disposed in the second region.

8. The polarizer of claim 1, wherein the single piece of glass further comprises a third region of wire-grid glass to polarize light incident on the third region, the third region of wire-grid glass having a grid of metallic wires distinct from and not parallel to the grid of metallic wires of the second region.

9. A polarization system, comprising:
a single piece of glass, comprising:
a first region of bare glass to provide null polarization for light incident on the first region, and
a second region of wire-grid glass having a grid of metallic wires, to polarize light incident on the second region; and
a motor to rotate the piece of glass.

10. The polarization system of claim 9, further comprising a stage assembly in which the piece of glass is mounted, wherein the motor is to rotate the stage assembly.

11. The polarization system of claim 10, further comprising a frame surrounding the first region and the second region, wherein the frame is connected to the stage assembly.

12. The polarization system of claim 9, wherein:
the second region composes a majority of the piece of glass;
the piece of glass is rotatable by the motor to a first orientation at which light for a target is to pass only through the first region; and
the piece of glass is rotatable by the motor to a plurality of orientations, distinct from the first orientation, at which light for the target is to pass only through the second region.

13. The polarization system of claim 12, wherein the piece of glass is rotatable by the motor through 180 degrees while light for the target is to pass only through the second region.

14. The polarization system of claim 9, wherein the single piece of glass further comprises a third region of wire-grid glass to polarize light incident on the third region, the third region of wire-grid glass having a grid of metallic wires distinct from and not parallel to the grid of metallic wires of the second region.

15. A method, comprising:
providing a single piece of glass comprising:
a first region of bare glass to provide null polarization for light incident on the first region, and
a second region of wire-grid glass having a grid of metallic wires, to polarize light incident on the second region;
rotating the piece of glass to a first orientation; and
with the piece of glass at the first orientation, illuminating a target with light that either passes only through the first region or only through the second region.

16. The method of claim 15, wherein the illuminating comprises illuminating the target with light that passes only through the first region, the method further comprising:
rotating the piece of glass to a second orientation; and
with the piece of glass at the second orientation, illuminating the target with light that passes only through the second region.

17. The method of claim 16, further comprising:
rotating the piece of glass to a third orientation; and
with the piece of glass at the third orientation, illuminating the target with light that passes only through the second region;
wherein the light that passes only through the second region with the piece of glass at the second orientation is provided with a different polarization than the light that passes only through the second region with the piece of glass at the third orientation.

18. The method of claim 15, wherein the illuminating comprises illuminating the target with light that passes only through the second region, the method further comprising:
rotating the piece of glass to a second orientation; and
with the piece of glass at the second orientation, illuminating the target with light that passes only through the second region;
wherein the light that passes only through the second region with the piece of glass at the first orientation is provided with a different polarization than the light that passes only through the second region with the piece of glass at the second orientation.

19. The method of claim 18, further comprising:
rotating the piece of glass to a third orientation; and
with the piece of glass at the third orientation, illuminating the target with light that passes only through the first region.

20. The method of claim 15, wherein:
the single piece of glass further comprises a third region of wire-grid glass to polarize light incident on the third region, the third region of wire-grid glass having a grid of metallic wires distinct from and not parallel to the grid of metallic wires of the second region; and
the method further comprises:
rotating the piece of glass to a second orientation; and
with the piece of glass at the second orientation, illuminating the target with light that either passes only through the third region.
